(19) United States
(12) Patent Application Publication
(10) Pub. No.: US 2018/0035699 A1
(43) Pub. Date: Feb. 8, 2018

(54) READY-TO-EAT, SHELF-STABLE TATER TOT-TYPE SNACK FOOD

(71) Applicant: Continental Mills, Inc., Tukwila, WA (US)

(72) Inventors: Annette Jones, Tukwila, WA (US); Stephen Green, Tukwila, WA (US); Yash Burgula, Tukwila, WA (US); Kelly Duffin-Maxwell, Tukwila, WA (US)

(21) Appl. No.: 15/670,104

(22) Filed: Aug. 7, 2017

Related U.S. Application Data
(60) Provisional application No. 62/371,631, filed on Aug. 5, 2016.

(51) Int. Cl. A23L 19/12; A23L 3/36; A23B 7/04; A23L 5/10

(52) U.S. Cl. CPC A23L 19/12; A23L 5/10; A23L 3/36; A23B 7/04; A23V 2002/00

(57) ABSTRACT

A ready-to-eat, shelf-stable tater-tot type snack food made from one or more of the following food products: vegetable (including starches from root vegetables), fruit, meat, bean, or meat analog. The tater tot-type snack food has a crispy outer layer or layers and crunchiness throughout the tater tot-type snack food. The tater tot-type snack food does not require cooking or warming prior to consumption. The tater tot-type snack food has extended shelf stability, especially when packaged in an oxygen free environment. The tater tot-type snack food can be manufactured using either freeze drying or vacuum frying techniques.

### BACKGROUND

Convenience is a primary attribute desired by consumers of snack foods. As such, there is a continuous demand for snack foods that require little or no preparation prior to consumption, and which can be stored at room temperature for relatively long periods of time without going stale or otherwise deteriorating in quality.

Variety is also desired by snack food consumers. One way to provide variety in snack foods is by varying the texture of different snack foods. Textural differences create primary differentiation for snack food consumers who seek attributes from soft and chewy to crispy and crunchy. Manipulating textural attributes can significantly increase the overall preference and favorability of snack food products. Unfortunately, the type of ready-to-eat snack foods available to the public has generally remained stagnant over the past several years.

Accordingly, a demand exists for new ready-to-eat and shelf-stable snack foods. A demand also exists for these new ready-to-eat and shelf-stable snack foods to be low cost, healthy, and, in some instances, free of certain components, such as allergens, gluten, and GMOs.

### BRIEF DESCRIPTION OF THE DRAWINGS

FIG. 1 is a perspective view of a tater tot-type snack food unit according to various embodiments described herein;

FIG. 2 is a flow chart illustrating a process for manufacturing tater-tot type snack foods according to various embodiments described herein; and

FIG. 3 is a flow chart illustrating another process for manufacturing tater-tot type snack foods according to various embodiments described herein.

FIGS. 4A, 4B, 4C and 4D present summaries of the results of testing the crispness of example batchs of tater-tot type snack foods.

### DETAILED DESCRIPTION

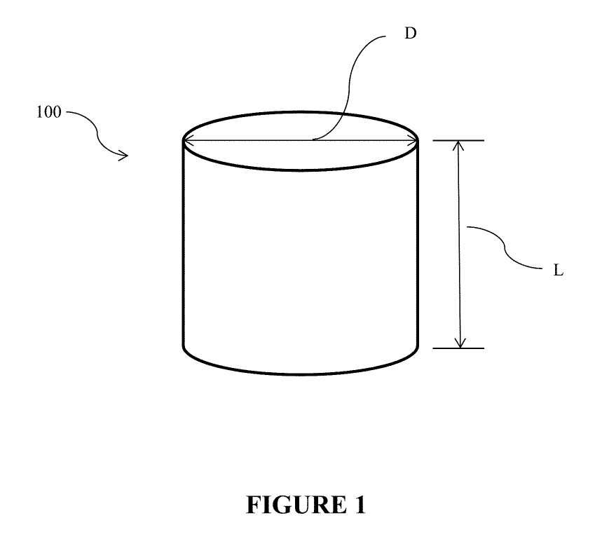

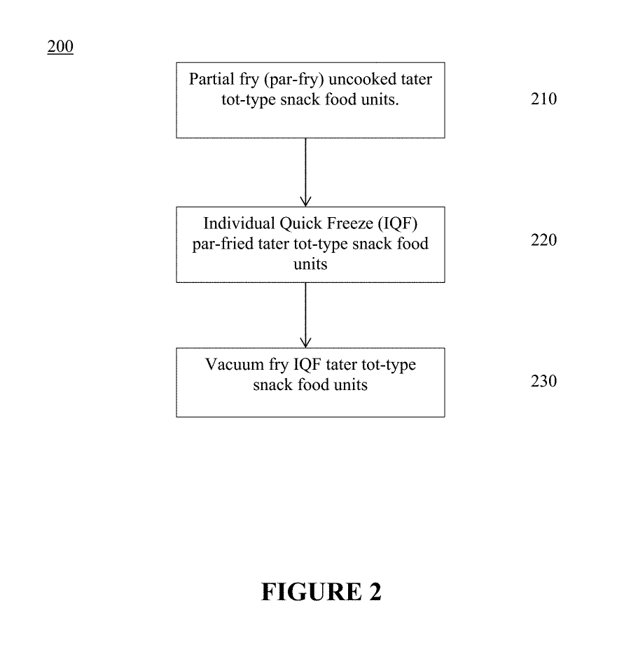

Certain details are set forth in the following description and FIGS. 1 and 2 to provide a thorough understanding of various embodiments of this disclosure. Those of ordinary skill in the relevant will appreciate, however, that the technology disclosed herein can have additional embodiments that may be practiced without several of the details described below and/or with additional features not described below. In addition, some well-known manufacturing techniques often associated with snack foods, and tater tot-type snack foods in particular, have not been shown or described in detail to avoid unnecessarily obscuring the description of the various embodiments of this disclosure.

In the Figures, identical reference numbers identify identical, or at least generally similar, elements. Many of the features shown in the Figures are merely illustrative of particular embodiments of the disclosure. Accordingly, other embodiments can have other features without departing from the spirit or scope of the present invention. In addition, those of ordinary skill in the art will appreciate that further embodiments of the invention can be practiced without several of the details described below.

In one embodiment, a ready-to-eat, shelf-stable snack food such as a tater tot-type snack food (also referred to herein generally as a “tater tot-type snack food”) is provided. The tater tot-type snack food can have the general form of a traditional tater tot in that it can be made from shreds or pieces of, e.g., potato (with or without skin on) that are compacted into a shape via, e.g., an extrusion process. However, unlike traditional tater tots that may have a fried, somewhat firm outer exterior and softer interior, the tater tot-type snack food described herein can have a crispy outer layer or layers and crunchiness throughout the tater tot-type snack food. Additionally, unlike traditional tater tots, the moisture content of the tater tot-type snack food of the present disclosure can be in the range of from 0.2 to 3 wt. %, thereby making the tater tot-type snack food a generally dry snack food. Further still, the tater tot-type snack food described herein differs from traditional tater tots in that the tater tot-type snack food does not require cooking or warming prior to consumption.

The term “tater tot” traditionally refers to a cylindrical-shaped food product made from compacted pieces or shreds of a potato. However, as used herein, the term “tater tot” should not be construed to be limited to potato-based snack foods or to any specific shape. For example, the tater tot-type snack food described herein can be derived from any root vegetable and can be provided in a variety of different shapes. Additionally, the term “tater tot” as used herein may refer to a unit including shreds, pieces, mash, and/or whole pieces of the food product from which it is derived.

The term “ready-to-eat” as used herein generally means that the tater tot-type snack food is in a form that is edible without additional preparation required to make the snack food safe for consumption. Additional preparation includes, but is not limited to, cooking, heating, warming, or thawing. In some embodiments, “ready-to-eat” further denotes that the snack food is suitable and designed for consumption when the product is at or about room temperature.

The term “shelf-stable” as used herein generally means that the tater tot-type snack food can be stored at room temperature for a prolonged period of time without the tater tot-type snack food going stale, spoiling, growing mold, and/or otherwise becoming unsafe or undesirable to consume. In some embodiments, a prolonged period of time means longer than 1 month, longer than 3 months, or longer than 6 months, but typically less than 9 months. The shelf-stability of the tater tot-type snack food can be extended by storing the tater tot-type snack food in packaging that eliminates or at least reduces the tater tot-type snack food's exposure to air. For example, packaging with a metalized interior film and nitrogen flush can prolong the shelf-stability to 6 to 9 months.

The tater tot-type snack food described herein comprises shreds, pieces and/or mash of a food that are compacted into individual units, and/or whole pieces of a food (skin on or skin removed) that are processed in such a way as to provide the tater tot-type snack food with a crispy exterior layer or layers and a crunchy consistency throughout the interior. When a mash is used, the mash can be re-constituted from a powdered base.

The food from which the shreds, pieces, mash or whole pieces are derived can be any type of root vegetable, which as the term is used herein includes, but is not limited to, tuberous roots, taproots, tubers, rhizomes, corms and bulbs. Exemplary root vegetables suitable for use as the source of the shreds or pieces include, but are not limited to, potatoes, yams, beets, carrots, radishes, turnips, yuca and sweet potatoes. In some embodiments, the tater tot-type snack food can be made from pieces, shreds, mash, and/or whole pieces of potatoes. Any type of potato may be suitable for use as the source of the pieces or shreds. Non-limiting examples of types of potatoes suitable for use in the tater tot-type snack food described herein include russet, red, yellow, Yukon, purple potatoes and blue potatoes.

Non-root vegetable foods can also be used for the tater tot-type snack food described herein. In some embodiments, the shreds, pieces, mash, and/or whole pieces of the tater tot-type food are derived from a fruit (e.g., pineapple, apple, mango, coconut, pear, banana, jack fruit, peach, blueberry, strawberry, etc.) or vegetable (e.g., cauliflower, carrot, broccoli, etc.). Other foods that can be used for the tater tot-type snack food include, but are not limited to, beans (e.g., black, pinto, kidney, lentil, chickpea, etc.), meat (e.g., bacon, jerky, beef, pork, chicken, turkey, stock, bone broth, etc.), and meat substitutes (e.g., faux-bacon, soy protein isolates pea protein concentrate).

In some embodiments, the tater tot-type snack food is made primarily from shreds or pieces of a first food product, such as a root vegetable, and further includes inclusions of one or more different foods. For example, the tater tot-type snack food can be made primarily from shreds or pieces of potato while having included therein shreds or pieces of another food, such as one or more of the fruits, vegetables, beans, meats, and meat substitutes described previously. Dairy-based inclusions can also be provided within the tater tot-type snack food, such as shreds or pieces of cheese (e.g., cheddar, parmesan, Swiss, gouda, etc.). When a secondary food product is worked in with the primary food product of the tater tot-type snack food, the secondary food product can be provided in the form of a visual particulate so as to provide a visual contrast within the tater tot-type snack food. In this regard, the tater tot-type snack food can also include edible decorative particulates, such as edible glitter. Additional components that can be included in the tater tot-type snack food include anti-oxidants, such as Rosemary extract.

In some embodiments, the shreds or pieces used in the tater tot-type snack food can be generally elongated thin pieces or shreds. In some embodiments, the shreds or pieces can have a length in the range of from about 0.05 cm to about 5 cm, such as from about 0.1 cm to about 2.5 cm. In addition to shreds and pieces, potato pulp (either blanched or baked) can also be used in the tater tot-type snack food. In some embodiments, the potato pulp is used in conjunction with shreds or pieces in order to increasing the binding of the tater tot-type snack food. Other suitable binders that can be used include, but are not limited to, starches, potato-based flakes and granules, flours, protein, and powders from plant or animal sources.

The shape of the tater tot-type snack food can be generally cylindrical. FIG. 1 illustrates an exemplary tater tot-type snack food 100 having a cylindrical shape according to various embodiments described herein. In some embodiments, the length L of the cylindrical tater tot-type snack food 100 can be in the range of from about 0.5 inches to about 2.0 inches, such as about 1 inch to about 1.5 inches. In some embodiments, the diameter D of the cylindrical tater tot-type snack food 100 can be in the range of from about 0.3 inches to about 2.0 inches, such as about 0.6 inches to about 1 inch. While a generally cylindrical shape (including circular, oval, square, rectangular, star, etc., cross-sections) is used in some embodiments, other shapes can also be used. For example, in some embodiments the tater tot-type snack food may have a spherical shape or a coin shape. The tater tot-type snack food can also be pressed into other unique shapes, such as wedges, stars, smiles, curls, hash browns, emojis, letters of the alphabet, numbers, etc. When whole pieces of food are used, these whole pieces can be carved, cut, or otherwise formed into similar shapes as mentioned previously. The size of the various shapes can also be variable, including miniature-sized tater tot shapes.

The tater tot-type snack food 100 can include several properties that impact the sensory characteristics of the tater tot-type snack food, including, for example, the moisture content, water activity, crispness, and crunchiness of the tater tot-type snack food. With respect to moisture content, the tater tot-type snack food 100 described herein can have a moisture content in the range of from about 0.1 to about 3.5 wt. %, and in some embodiments, from about 0.4 to about 2 wt. %, such as about 0.8 wt. %. Moisture content is calculated by dividing the weight of the water content in an individual tater tot-type snack food unit by the total weight of the same individual tater tot-type snack food unit. The relatively low moisture content of the tater tot-type snack food described herein results in a snack food that is generally dry. This low moisture content can contribute to the prolonged shelf-stability of the disclosed snack food.

Regarding water activity, the tater tot-type snack food 100 can have a water activity in the range of from about 0.09 to about 0.85. In some preferred embodiments, the water activity of the tater tot-type snack food is from about 0.18 to about 0.44, such as about 0.21. Water activity is calculated by dividing the partial vapor pressure of water in the tater tot-type snack food by the standard state partial vapor pressure of water. Water activity can be measured by, for example, a water activity meter, such as the Aqua Lab 4TEV.

Regarding crispness, the tater tot-type snack food 100 can generally include an exterior layer or outer-most layers that impart the tater tot-type snack food with a relatively high level of crispness. Various studies have been carried out in order to produce a measurement and definition for crispness. For example, Critical Evaluation of Crispy and Crunchy Textures: A Review (Tunick et al., Int. J. of Food Properties, 2013, the entirety of which is hereby incorporated by reference) provides a measurement system and definition for crispness. Tunick describes crispness as dry rigid food which, when bitten with incisors, fractures quickly, easily and totally while emitting a relatively loud, high-pitched sound. Crispness therefore generally relates to the sensory attributes at initial breakthrough of the surface of a food product.

Crispness can also be measured using analytical equipment. In some embodiments, the crispness is measured using a texture profile analyzer, such as the TMS-PRO manufactured by Food Technology Corporation. Crispness is measured by a texture profile analyzer by determining the force needed to break through an exterior layer of the tater tot-type snack food. In some embodiments, the crispness measurement for the tater tot-type snack food described herein is in the range of from about 10 to about 90 N.

Regarding crunchiness, the tater tot-type snack food 100 can generally include an overall structure that has a high level of crunchiness. As with crispness, Tunick also provides a definition and measurement system for crunchiness. Tunick describes crunchiness as a dense-textured food which, when chewed with the molars, undergoes a series of fractures while emitting relatively loud, low-pitched sounds. Crunchiness therefore generally relates to the force required to continuously breakthrough the entirety of the food product, including the interior layers, and the noise associated therewith.

Crunchiness can also be measured using analytical equipment. In some embodiments, the crunchiness is measured using a texture profile analyzer, such as the TMS-PRO manufactured by Food Technology Corporation. Crunchiness is measured by a texture profile analyzer by descending a probe into the tater tot-type snack food at 80 mm/sec, with the probe measuring resistance coming from the tater tot-type snack food. The probe penetrates 20 mm, then backs off 40 mm. Two cycles are completed. The data is plotted as force/resistance as a function of time, which produces a series of peaks. Each peak typically corresponds to a single crunch associated with the tater tot-type snack food. The greater the number of peaks produced, the crunchier the product. In some embodiments, the crunchiness measurement for the tater tot-type snack food described herein is in the range of from about 2 to 50 peaks.

Another characteristic of the tater tot-type snack food 100 is the density. The tater tot-type snack food can be generally light and airy and therefore have a relatively low density. In some embodiments, the density of the tater-tot type snack food described herein can be in the range of from about 0.23 oz/L to about 0.35.0 oz/L, and in some embodiments from about 0.24 oz/L to about 0.33 oz/L, such as about 0.28 oz/L. As is apparent from the unit used for density, density is calculated by measuring the weight of the tater tot-type snack food that fills a prescribed volume.

The tater tot-type snack food 100 can have similar taste properties to that of a traditional cooked tater tot. For example, the tater tot-type snack food can taste of a cooked potato fried in oil and include similar flavor notes associated with the browning of traditional tater tot. The tater tot-type snack food can retain the same fried oil taste characteristics of a traditional tater tot. The fried oil taste generally derives from the processing method for the tater tot-type snack food, which may use an oil during one or more steps. The type of oil used and which may generally add flavor to the tater tot-type snack food is generally not limited, and in some embodiments can be selected from sunflower oil, cottonseed oil, canola oil, soybean oil, corn oil, olive oil, tallow oil, vegetable oil, avocado oil, coconut oil, and safflower oil. Other high-stability, high-oleic type oils can also be used. Further still, the tater tot-type snack food can have minimal off-notes, such as starchiness.

In some embodiments, the tater tot-type snack food 100 can have a seasoning applied to the exterior of the tater tot-type snack food and/or incorporated into the interior of the tater tot-type snack food. Any type of seasoning can be used and can be added to the tater tot-type snack in any amount. Non-limiting examples of seasonings suitable for use with the tater tot-type snack food include Cheese, Onion, Cajun, Barbeque, and Sea-salt.

In some embodiments, the tater tot-type snack food 100 herein can be manufactured to avoid the presence of certain components in the tater tot-type snack food. For example, the manufacturing can be carried out so that the tater tot-type snack food is free of artificial flavors, artificial colors, artificial preservatives, trans fat, gluten, allergens such as nuts, and/or GMOs. The manufacturing process can also be carried out such that the tater tot-type snack food is kosher.

Manufacturing methods for preparing the tater tot-type snack food 100 are set forth in detail below. The processes can generally begin with the formation of uncooked tater tot-type snack food units in a manner similar or identical to conventional methods for forming traditional tater tots. In such methods, shreds, pieces, pulp, and/or mash of a specific food (e.g., vegetables such as potatoes) are provided and subsequently mixed with secondary components to form a mixture. Secondary components are generally not limited and may include, for example, salt, starch (such as corn, potato, wheat, etc.), dextrose, disodium dihydrogen pyrophosphate, onion powder, and other natural flavors. This mixture of shreds or pieces and the secondary components are then typically extruded through a die of appropriate shape and dimension. As the extrudate leaves the die, individual tater tot units are formed by cutting the extrudate at intervals corresponding to the desired length of the tater tot units. Molding techniques known to those of ordinary skill in the art can also be used to form the mixture of shreds or pieces and secondary components into a traditional tater tot form. The formation of uncooked tater tot-type snack food units can also be carried out by cutting whole pieces from a food product, with or without the skin still on.

In an optional step, the uncooked tater tot-type snack food units can be dipped into a batter, such as a batter traditionally used in the preparation of traditional tater tots, and/or coated with a material that helps lend stability to the individual units.

Once the uncooked tater tot-type snack food units are formed as described above, the subsequent manufacturing method can be carried according to one of at least two separate processes. A first process uses vacuum frying technology to manufacture the tater tot-type snack food, and a second process uses freeze drying technology to manufacture the tater tot-type snack food. Either manufacturing process is acceptable, though tater tot-type snack food of slightly varying characteristics are produced as a result of the separate methods.

FIG. 2 describes a vacuum frying method 200 in accordance with the present technology. In step 210, the uncooked tater tot-type snack food units described in the preceding paragraphs are partial-fried (referred to as “par-fry”). In step 220, the par-fried tater tot-type snack food units are individual quick frozen (IQF). In step 230, the IQF tater tot-type snack food units are vacuum fried. The vacuum fry step dehydrates the tater tot-type snack food units and produces the crispness/crunchiness characteristics described previously.

In step 210, the uncooked tater tot-type snack food units can be subjected to a par-fry process. The par-fry process generally involves submerging the uncooked tater tot-type snack food units in oil at a specified temperature for a relatively short period of time, which thereby leads to a partial fry of the individual units. In some embodiments, the par-fry process can be carried out in an oil heated to a temperature of between about 325° F. and about 375° F., such as about 340° F. to about 360° F. The units can be submerged in the heated oil for a time period in the range of from about 30 to about 120 seconds, such as from about 35 to about 40 seconds. The type of oil used is generally not limited, and in some embodiments can be selected from sunflower oil, cottonseed oil, canola oil, soybean oil, corn oil, olive oil, tallow oil, vegetable oil, avocado oil, coconut oil, and safflower oil. Other high-stability, high-oleic type oils can also be used. Following the par-fry step, the tater tot-type snack food can have a moisture content in the range of from about 30 wt. % to about 80 wt. %, such as about 70 wt. %.

In step 220, the par-fried tater tot-type snack food units produced from step 110 are subjected to individual quick freezing. The IQF process generally involves freezing the individual units of the tater tot-type snack food so they are individually frozen, rather than freezing the units together as a block. The process generally entails sending the individual units on a conveyor belt into a blast-freezer that freezes each individual unit quickly. IQF can be performed using, e.g., flighted spiral freezers or cryogenic freezers. In some embodiments, the IQF step 220 may be eliminated. However, in some embodiments, performing an IQF step helps to hold each individual tater tot-type unit together.

In step 230, the IQF units are subjected to vacuum frying. Vacuum frying generally entails performing deep frying of a food product inside of a vacuum chamber in which the pressure is altered from atmospheric pressure. In some embodiments, the vacuum frying step 130 can be carried out using oil heated to a temperature in the range of from about 100° C. to about 180° C., and in some embodiments from about 100° C. to about 130° C., such as about 120° C. The type of oil used is generally not limited, and in some embodiments can be selected from sunflower oil, cottonseed oil, canola oil, soybean oil, corn oil, olive oil, tallow oil, vegetable oil, avocado oil, coconut oil, and safflower oil, or other high-stability, high-oleic type oils. The vacuum frying can be carried out for a time period of between about 1 minutes to about 40 minutes, and in some embodiments from about 9 minutes to about 25 minutes, such as about 17.5 minutes. In some embodiments, vacuum frying is carried out at a pressure in the range of from about 1 Hg to about 30 Hg, and in some embodiments from about 25 Hg to about 27 Hg, such as about 26 Hg. In some embodiments, the vacuum frying is carried out in a batch process rather than on a continuous basis. The vacuum frying process results in the dehydration of the IQF units such that the moisture content can be reduced down to in the range of about 0.1 to 3.5 wt. %. The vacuum frying step also produces a tater tot-type snack food product having the crispness and crunchiness characteristics described previously.

In some embodiments, step 230 will not be performed immediately after step 220, such as in situations where the IQF step is performed at a facility that is separate from where vacuum frying is performed. In such instances, the IQF units may need to be stored and/or transported between steps 220 and 230. Generally speaking, the storing and transporting of IQF units should be done at freezing temperatures to maintain the frozen state of the IQF units. Any suitable method for maintaining freezing temperatures during storing and transporting can be used.

In some embodiments, the process illustrated in FIG. 1 can include one or more seasoning steps. Seasoning steps can be performed, for example, between the formation of the uncooked tater tot-type snack food units and the par-fry step 210 and/or after the vacuum frying step 230. Seasoning can be carried out using any known techniques, such as by sprinkling or using an oil spray to improve adherence of seasoning to the tater tot-type snack food.

Following formation of the tater tot-type snack food via the vacuum frying method 200, the tater tot-type snack food may be packaged. The type of packaging used for the tater tot-type snack food is generally not limited. In some embodiments, the tater tot-type snack food is packaged in bags having metalized interior films. The packaging can also be subjected to, for example, a nitrogen flush, to remove oxygen from the packaging. Various types of packaging can increase the shelf-stability of the tater tot-type snack food described herein, such as prolonging the shelf-stability to 6 to 9 months.

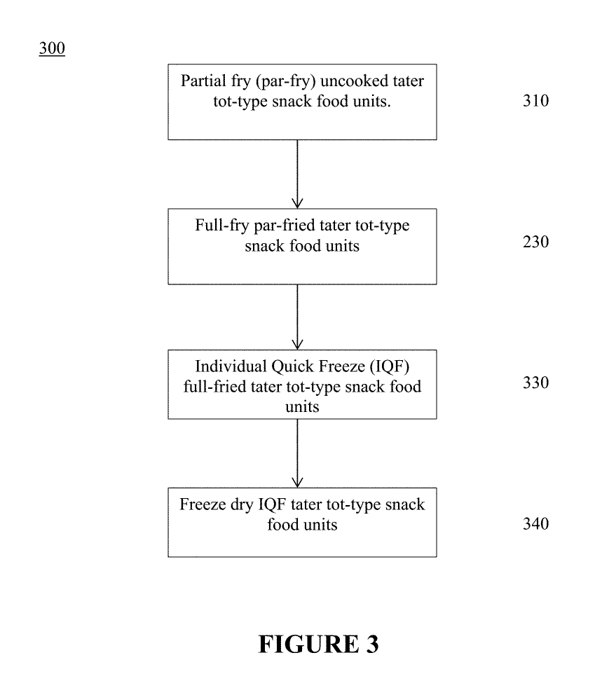

FIG. 3 describes a freeze drying method 300 in accordance with the present technology. In step 310, the uncooked tater tot-type snack food units described previously are par-fried. In step 320, the par-fried tater tot-type snack food is subjected to a finish fry step. In step 330, the tater tot-type snack food units are individual quick frozen (IQF). In step 340, the IQF tater tot-type snack food units are freeze dried. The freeze drying step dehydrates the tater tot-type snack food units and produces the crispness/crunchiness characteristics described previously.

In step 310, the uncooked tater tot-type snack food units can be subjected to a par-fry process. The par-fry step 310 can be similar or identical to the par-fry step 210 described previously. In the par-fry step, the uncooked tater tot-type snack food units are submerged in oil heated to a specified temperature for a relatively short period of time, which thereby leads to a partial fry of the units. In some embodiments, the par-fry process can be carried out in an oil heated to a temperature of between about 325° F. to about 375° F., such as about 340° F. to about 360° F. The units can be submerged in the heated oil for a time period in the range of from about 30 to about 120 seconds, such as about 35 to about 40 seconds. The type of oil used is generally not limited, and in some embodiments can be selected from sunflower oil, cottonseed oil, canola oil, soybean oil, corn oil, olive oil, tallow oil, vegetable oil, avocado oil, coconut oil, and safflower oil. Other high-stability, high-oleic type oils can also be used. Following the par-fry step, the tater tot-type snack food can have a moisture content in the range of from about 40 to about 70 wt. %.

In step 320, a finish fry is carried out. The finish fry step is carried out in generally a similar fashion to the par-fry step, in that the par-fried units are submerged in a heated oil for a prescribed period of time. In some embodiments, the oil used in the finish fry step is heated to between about 340° F. to about 360° F. The units can be submerged for a period of time ranging from about 20 seconds to about 30 seconds. The finish fry step brings the moisture content of the tater tot-type snack food to between about 25 wt % and about 45 wt %. The finish fry step also provides the tater tot-type snack food with the desired crispness and crunchiness characteristics and also serves as a kill step.

In step 330, the fried tater tot-type snack food units produced from step 320 are subjected to individual quick freezing. The IQF step 330 can be similar or identical to the IQF step 220 described previously. The individual units of the tater tot-type snack food are individually frozen, rather than freezing the units together as a block. The individual units can be placed on a conveyor belt and transported into a blast-freezer that freezes each individual unit quickly. The IQF step 330 can be performed using, e.g., flighted spiral freezers or cryogenic freezers.

In step 340, the IQF units are subjected to freeze drying. Freeze drying generally includes freezing the material and then reducing the surrounding pressure to allow the frozen water in the material to sublimate directly from the solid phase to the gas phase. In some embodiments, the IQF step 330 serves the freezing function of the freeze drying process. Any equipment suitable for carrying out freeze drying can be used in step 340. Because the individual units arrive at step 340 in an already frozen state, the freeze drying step 340 is aimed primarily at the adjustment to the pressure to sublimate the frozen water content of the individual units. In some embodiments, the freeze drying step 340 is carried out at a temperature in the range of from about 78° F. to about 245° F. for about 18 hours to about 24 hours and at a pressure of from about 1 kPa to about 100 kPa. In some embodiments, the freeze dry step 340 is performed two or more times. Each freeze dry step performed is carried out on a batch basis. At the end of the freeze dry step, the tater tot-type snack food has a moisture content in the range of from about 0.1 to about 3.5 wt %, such as about 1%, and retains the crispness and crunchiness characteristics.

In some embodiments, step 340 is not performed immediately after step 330, such as in situations where the IQF step is performed at a facility that is separate from where freeze drying is performed. In such instances, the IQF units may need to be stored and/or transported between steps 330 and 340. Generally speaking, the storing and transporting of IQF units should be done at freezing temperatures to maintain the frozen state of the IQF units. Any suitable method for maintaining freezing temperatures during storing and transporting can be used.

In some embodiments, the process illustrated in FIG. 3 can include one or more seasoning steps. Seasoning steps can be performed, for example, between the formation of the uncooked tater tot-type snack food units and the par-fry step 310, between the finish fry step 320 and the IQF step 330, and/or after the freeze drying step 340. Seasoning can be carried out using any known techniques, such as by sprinkling, tumbling, spray coating, and water-fall type applications. The use of an oil spray prior to seasoning can help adherence of seasoning to the tater tot-type snack food.

Following formation of the tater tot-type snack food via the freeze drying method 300, the tater tot-type snack food may be packaged. The type of packaging used for the tater tot-type snack food is generally not limited. In some embodiments, the tater tot-type snack food is packaged in bags having metalized interior films. The packaging can also be subjected to, for example, a nitrogen flush, to remove oxygen from the packaging. Various types of packaging can increase the shelf-stability of the tater tot-type snack food described herein, such as prolonging the shelf-stability to 6 to 9 months.

With respect to both vacuum frying method 200 and freeze drying method 300, an additional pre-treatment step may be carried out prior to step 210 or 310. This pre-treatment step is aimed at further aiding in the dehydration of the tater tot-type snack food. In some embodiments, the pre-treatment dehydration step is carried out in an oven, such as an impingement oven, a convention oven or a convection oven. In some embodiments, the pre-treatment dehydration step is carried out at a temperature of from about 200 to about 500° F., and in some embodiments from about 350 to about 500° F., such as about 425° F. In some embodiments, the pre-treatment dehydration step is carried out for a period of time ranging from about 1 to about 40 minutes, and in some embodiments from about 5 to about 20 minutes, such as about 10 minutes.

### EXAMPLES

### Example 1

### Effect of Preheating on Crispness

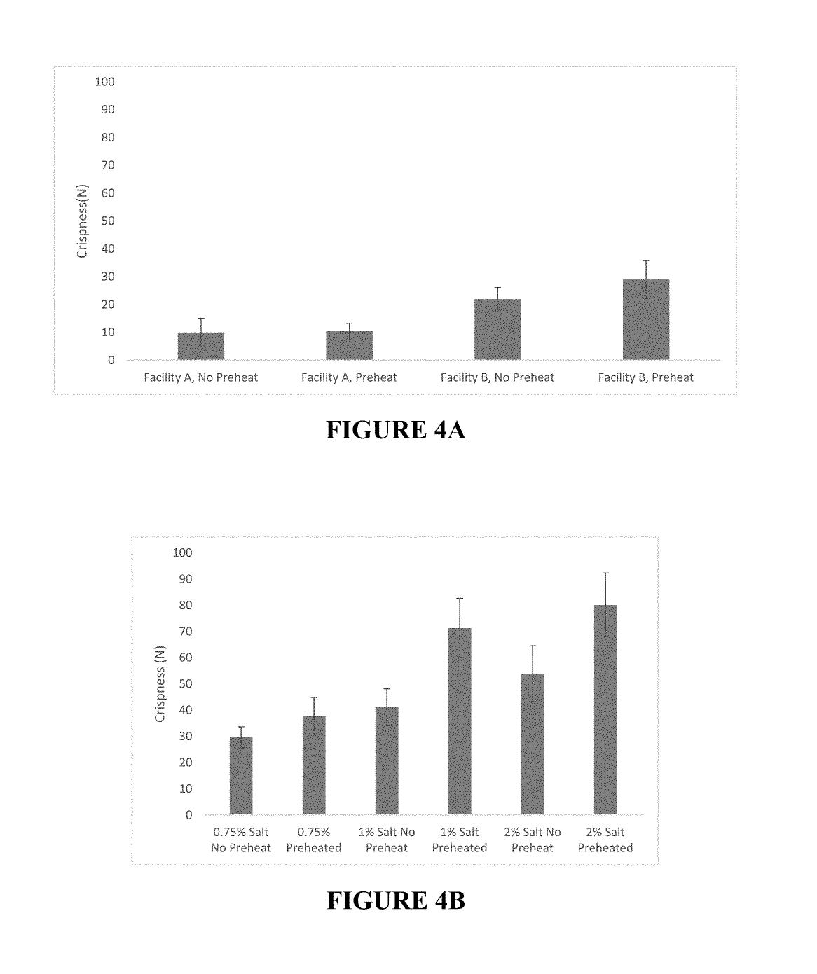

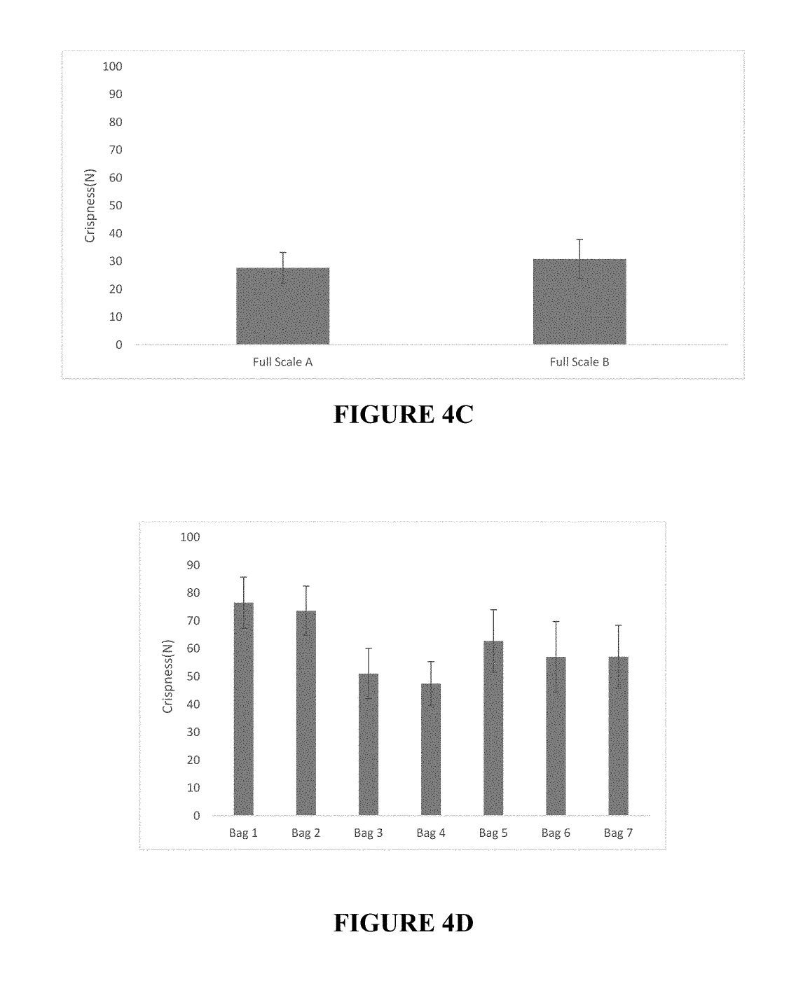

Tater tot-type snack food was prepared according to the vacuum frying procedure outlined herein. The initial steps of forming the shaped units were carried out in two separate facilities (Facility A and Facility B). The shaped units formed at each facility were then transported to a common facility where an optional pretreatment step was carried out, followed by the vacuum frying step. The crispness of each batch of the tater tot-type snack food was tested using a texture profile analyzer as described herein. Table 1 and FIG. 4A summarize the results of this testing, which generally show that crispness is increased with the use of a preheating step.

TABLE 1

| | Facility A, | Facility A, | Facility B, | Facility B, |
|---|---|---|---|---|
| | No Preheating | Preheating | No Preheating | Preheating |
| Crispness (N) | 9.97 | 10.48 | 21.97 | 28.99 |
| Std Dev | 5.08 | 2.8 | 4.14 | 6.82 |
| Coefficient of | 51 | 26.7 | 18.8 | 23.5 |
| variation (%) | | | | |

### Example 2

### Effect of Preheating on Crispness at Varying Salt Amounts

Tater tot-type snack food was prepared according to the vacuum frying procedures outlined herein, with varying amounts of salt used for different batches. At each salt amount, a batch was prepared using a preheating step and without a preheating step. The crispness of each batch of the tater tot-type snack food was tested using a texture profile analyzer as described herein. Table 2 and FIG. 4B summarize the results of this testing, which generally show that crispness is increased with the use of a preheating step, regardless of salt amount.

TABLE 2

| | 0.75% Salt, | 0.75 Salt, | 1% Salt, No | 1% Salt, | 2% Salt, No | 2% Salt, |
|---|---|---|---|---|---|---|
| | No Preheat | Preheat | Preheat | Preheat | Preheat | Preheat |
| Crispness (N) | 29.63 | 37.67 | 41.14 | 71.32 | 53.93 | 80.08 |
| Std Dev | 4 | 7.18 | 7.01 | 11.3 | 10.6 | 12.2 |
| Coefficient of | 19.06 | 13.5 | 17.04 | 15.84 | 19.66 | 15.23 |
| Variation (%) | | | | | | |

### Example 3

### Full Scale Crispness Results

Two full scale batches of tater tot-type snack food were prepared according to the vacuum frying procedures set forth herein. The crispness of each batch of the tater tot-type snack food was tested using a texture profile analyzer as described herein. Table 3 and FIG. 4C summarize the results of this testing.

TABLE 3

| | Full Scale A | Full Scale B |
|---|---|---|
| Crispness (N) | 27.66 | 30.84 |
| Std Dev | 5.53 | 7.06 |
| Coefficient of Variation (%) | 19.99 | 22.89 |

### Example 4

### Crispness Using Freeze Dried Method

Seven batches of the tater tot-type snack food as described herein was prepared using a method including a freeze drying step as described above with respect to method 300. The crispness of each batch of the tater tot-type snack food was tested using a texture profile analyzer as described herein. Table 4 and FIG. 4D summarize the results of this testing.

| | Bag 1 | Bag 2 | Bag 3 | Bag 4 | Bag 5 | Bag 6 | Bag 7 |
|---|---|---|---|---|---|---|---|
| Crispness (N) | 76.54 | 73.66 | 51.09 | 47.48 | 62.81 | 57.09 | 57.14 |
| Std Dev | 9.2 | 8.87 | 9.04 | 7.91 | 11.2 | 12.7 | 11.3 |
| Coefficient of | 12.01 | 12.04 | 17.69 | 16.66 | 17.83 | 22.25 | 19.78 |
| Variation (%) | | | | | | | |

From the foregoing, it will be appreciated that specific embodiments of the invention have been described herein for purposes of illustration, but that various modifications may be made without deviating from the scope of the invention. Accordingly, the invention is not limited except as by the appended claims. As used herein, the term “about” means +/−10%.

I/We claim:

1. A ready-to-eat tater tot-type snack food comprising:
shreds, pieces, mash, whole pieces or a combination thereof of a food product compacted into a form;
wherein the tater tot-type snack food has a moisture content in the range of from about 0.1 to about 3.5 wt. %, a crispness of from about 10 to about 90 N, and a crunchiness of from about 2 to about 50 peaks.

2. The ready-to-eat tater tot-type snack food of claim 1, wherein the food product is a vegetable, a fruit, a meat, a bean, or a meat substitute.

3. The ready-to-eat tater tot-type snack food of claim 2, wherein the food product is a vegetable and the vegetable is a root vegetable.

4. The ready-to-eat tater tot-type snack food of claim 1, wherein the tater tot-type snack food has a water activity in the range of from about 0.09 to about 0.85.

5. The ready-to-eat tater tot-type snack food of claim 1, wherein the tater tot-type snack food has a density in the range of from about 0.23 oz/L to about 0.35 oz/L.

6. The ready-to-eat tater tot-type snack food of claim 1, wherein the tater tot-type snack food has a water activity in the range of from about 0.18 to about 0.44 and a density in the range of from about 0.24 oz/L to about 0.33 oz/L.

7. A method of manufacturing a ready-to-eat tater tot-type snack food comprising:
compacting shreds, pieces, mash, or combinations thereof of a food product into individual shaped units or cutting whole pieces from a food product to form individual shaped units;
par-frying the individual shaped units;
individual quick freezing the individual shaped units; and
vacuum frying the individual shaped units.

8. The method of claim 7, wherein par-frying the individual shaped units comprises par-frying the individual shaped units in oil at a temperature of about 325 to about 375° F. for about 30 to about 120 seconds.

9. The method of claim 7, wherein vacuum frying the individual shaped units comprises vacuum frying the individual shaped units in oil at a temperature of from about 100 to about 180° C. at a pressure of from about 1 to about 30 Hg for about 1 to about 40 minutes.

10. The method of claim 1, wherein compacting shreds, pieces, mash, or combinations thereof into individual shaped units comprises compacting shreds, pieces, mash, or combination thereof into individual cylindrical-shaped units.

11. A method of manufacturing a ready-to-eat tater tot-type snack food comprising:
compacting shreds, pieces, mash, or combinations thereof of a food product into individual shaped units or cutting whole pieces from a food product to form individual shaped units;
par-frying the individual shaped units;
finish-frying the individual shaped units;
individual quick freezing the individual shaped units; and
freeze drying the individual shaped units.

12. The method of claim 11, wherein par-frying the individual shaped units comprises par-frying the individual shaped units in oil at a temperature of about 325 to about 375° F. for about 30 to about 120 seconds.

13. The method of claim 11, wherein finish-frying the individual shaped units comprises finish-frying the individual shaped units in oil at a temperature of about 340 to about 360° F. for about 20 to about 30 seconds.

14. The method of claim 11, wherein freeze drying the individual shaped units comprises freeze drying the individual shaped units at a temperature of about 78 to about 245° F. at a pressure of from about 1 to about 100 kPa for about 18 to about 24 hours.

15. The method of claim 11, wherein compacting shreds, pieces, mash, or combinations thereof into individual shaped units comprises compacting shreds, pieces, mash, or combination thereof into individual units.

16. The ready-to-eat tater tot-type snack food of claim 3, wherein the root vegetable is a potato.

17. The method of claim 8, wherein the oil is selected from the group consisting of sunflower oil, cottonseed oil, canola oil, soybean oil, corn oil, olive oil, tallow oil, vegetable oil, avocado oil, coconut oil, safflower oil, and combinations thereof.

18. The method of claim 13, wherein the oil is selected from the group consisting of sunflower oil, cottonseed oil, canola oil, soybean oil, corn oil, olive oil, tallow oil, vegetable oil, avocado oil, coconut oil, safflower oil, and combinations thereof.

19. The method of claim 7, wherein the shape of the individual shaped units is selected from the group consisting of cylinders, spheres, coins, wedges, stars, smiles, curls, hash browns, emojis, letters of the alphabet, and numbers.

20. The method of claim 11, wherein the shape of the individual shaped units is selected from the group consisting of cylinders, spheres, coins, wedges, stars, smiles, curls, hash browns, emojis, letters of the alphabet, and numbers.
